(19) United States
(12) Patent Application Publication
(10) Pub. No.: US 2004/0051194 A1
(43) Pub. Date: Mar. 18, 2004

(54) Malfunction detection method in injection molding machines

(75) Inventors: Takashi Yamazaki, Mishima-shi (JP); Haruyuki Matsubayashi, Numazu-shi (JP); Takeshi Abe, Mishima-shi (JP)

Correspondence Address: PILLSBURY WINTHROP, LLP, P.O. BOX 10500, MCLEAN, VA, 22102, US

(73) Assignee: TOSHIBA MACHINE CO., LTD., Tokyo (JP)

(21) Appl. No.: 10/658,370

(22) Filed: Sep. 10, 2003

(30) Foreign Application Priority Data
Sep. 17, 2002 (JP) 2002-270017

(51) Int. Cl. B29C 45/76

(52) U.S. Cl. 264/40.1; 264/328.1

(57) ABSTRACT

The force pushing the ejector pin when a molded product is ejected is obtained from the driving torque of the servomotor. A malfunction is detected in the ejection step as follows. First, a reference pattern is obtained in advance, when a molded product is normally removed. As the reference pattern, the relationship between torque of the servomotor and time from the initiation of ejecting the ejector pin or the position of an ejector pin is used. At least one monitoring zone is set based on the pattern and the upper and lower limits of torque of each of the monitoring zones are set. A torque value is monitored in each monitoring zone and when the torque value falls outside the upper and lower limits of any one of the monitoring zones, it is determined that a malfunction occurred and an alarm is raised.

### CROSS-REFERENCE TO RELATED APPLICATIONS

This application is based upon and claims the benefit of priority from the prior Japanese Patent Application No. 2002-270017, filed Sep. 17, 2002, the entire contents of which are incorporated herein by reference.

### BACKGROUND OF THE INVENTION

1. Field of the Invention

The present invention relates to a method of detecting a malfunction during the step of ejecting a molded product out of dies in an electric or hydraulic injection-molding machine.

2. Description of the Related Art

In the injection-molding machine, a molded product is obtained by closing the dies, supplying resin into the dies from an injection unit, setting the resin, opening the dies, pushing an ejector pin incorporated in a movable die out of the die surface, and removing the molded product from the die.

A malfunction in the ejection step can be detected by a method disclosed, for example, in Japanese Patent Application KOKAI publication No. 2002-018924. In this method, first, data of the torque of an ejector-pin driving motor versus time (or the position of the ejector pin) is obtained when a molded product is normally removed (normal operation). The data is stored as a reference pattern in a control system, and also the tolerance (a permissible deviation from the reference pattern) of the torque is set based on the reference pattern. Thereafter, the ejection step is performed while change of torque with time (or position of the ejector pin) is monitored. When a torque falls outside the tolerance, it is determined that a malfunction occurred and then an alarm is raised.

As described above, in the conventional malfunction detection method, torque of the ejector-pin driving motor with time (or position of the ejector pin) is monitored and compared with the reference pattern. However, in this case, since a large amount of data is required for storing the reference pattern in the memory of the control system, effective use of the memory is limited.

### BRIEF SUMMARY OF THE INVENTION

The present invention has been attained with the view toward overcoming the problems of a conventional malfunction detection method, particularly, during the ejecting step in an injection-molding machine. An object of the present invention is to provide a method of detecting a malfunction capable of accurately detecting a malfunction in the ejecting step and saving the capacity of a memory of a control system.

According to the present invention, there is provided a method of detecting a malfunction in an electric injection-molding machine, the method being applied to the step of ejecting a molded product by pushing an ejector pin out of a die, comprising:

obtaining, in advance, a pattern showing torque of an ejector-pin driving motor versus time or a position of an ejector pin when a molded product is normally removed:

setting in advance at least one monitoring zone and the upper and lower limits of torque in each of the monitoring zones based on the pattern; and

monitoring a torque value in each of the monitoring zones during the ejecting step, judging that a malfunction occurs when the torque value falls outside the upper and lower limits of the monitoring zone, and raising an alarm.

The time used here refers to the passage of time from initiation of pushing an ejector pin. The position used herein is the location of an ejector pin within the die.

According to the method of the present invention, a monitoring zone is previously set on the normal pattern (in the case of normally removing a molded product). For example, the monitoring zone is set within the period during which a relatively constant torque is obtained or in the period during which a specific pattern due to a malfunction is likely to appear. A malfunction can be accurately detected by monitoring the torque only in the monitoring zone.

According to the method of the present invention, one or more monitoring zones and the upper and lower limits of torque in each monitoring zone are simply set. Therefore, compared to a conventional method which needs to store a reference pattern itself, a small amount of data is only stored in the method of the present invention. As a result, the memory space of a control system can be saved.

In the method mentioned above, an alarm is raised immediately after a malfunction is detected. Instead, an alarm may be raised when the number of malfunctions detected in a single ejection step reaches a predetermined number.

Alternatively, an alarm may be raised when the number of malfunctions detected within a predetermined time reaches a predetermined number.

The method of detecting a malfunction may be applied to a hydraulic injection-molding machine in the same manner. In this case, the hydraulic pressure of an ejector-pin driving hydraulic pump is monitored in place of torque.

### BRIEF DESCRIPTION OF THE SEVERAL VIEWS OF THE DRAWING

FIG. 1 is a schematic diagram illustrating the structure of a motorized injection-molding machine to which the malfunction detection method according to the present invention is to be applied;

FIG. 2 is a graph showing an example of a pattern of driving torque versus time during a normal operation of the ejecting step;

FIG. 3 is a graph showing an example of monitoring zones and the upper and lower limits of the driving torque in each monitoring zone during the ejecting step;

FIG. 4 is a graph showing an example of a pattern of driving torque versus time when a malfunction takes place during the ejector-pin protruding step; and

FIG. 5 is a schematic diagram illustrating the structure of a hydraulic injection-molding machine to which the malfunction detection method according to the present invention is to be applied.

### DETAILED DESCRIPTION OF THE INVENTION

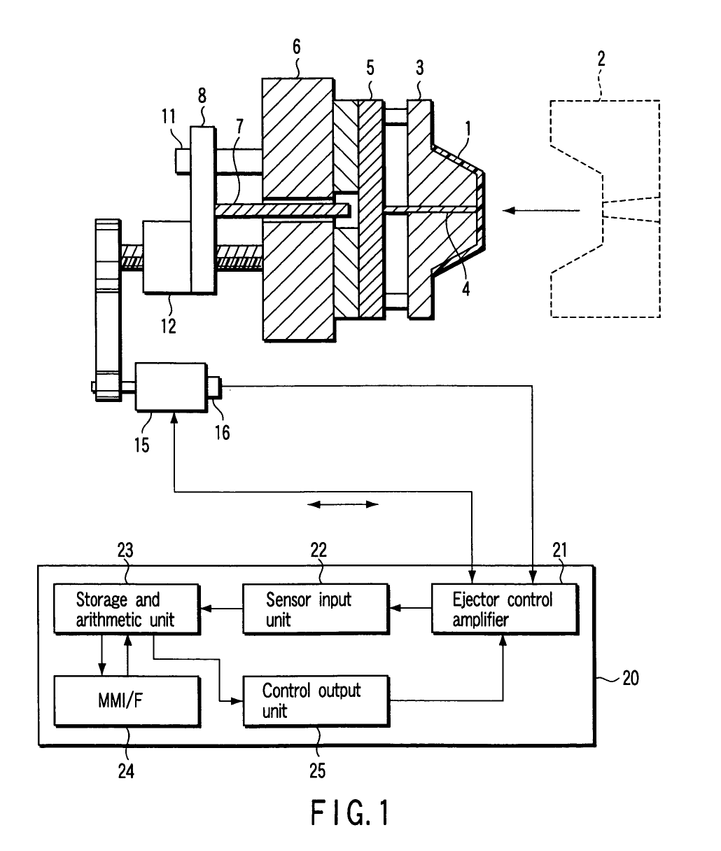

FIG. 1 is a schematic diagram illustrating the structure of an electric injection-molding machine to which the malfunction detection method according to the present invention is to be applied. In the figure, reference numeral 1 represents a molded product, 2 a stationary die, 3 a movable die, 4 is an ejector pin, 6 a movable platen, 15 a servo motor (ejector-pin driving motor), and 20 is a control system.

The movable die 3 is held on the front surface of the movable platen. The movable die 3 has a through-hole formed at the center along the axis. An ejector pin 4 slidably housed in the through-hole. The ejector plate 5 is arranged between the movable die 3 and the movable platen 6. The ejector plate 5 is supported by the front surface of the movable platen 6 so as to move back and forth. The rear end of the ejector pin 4 is fixed at the center of the ejector plate 5.

The movable platen 6 has a through-hole at the center along the axis and a rod 7 is movably placed in the through-hole. In the back of the movable platen 6, a plate 8 is arranged. The plate 8 is supported by a supporting rod 11 and a feed screw 12 so as to move back and forth with relative to the movable platen 6. The rear end of the rod 7 is fixed at the center of the plate 8. The feed screw 12 is connected to a servomotor 15 via gears. The position of the plate 8 can be obtained from the output of a rotational angle detector 16 attached to the servomotor 15.

In the injection molding machine, after the resin supplied between the stationary die 2 and movable die 3 is set, the movable die is moved away from the stationary die 2. A molded product 1 remains in the movable die 3 in contact with the front surface. Subsequently, the ejector pin 4 incorporated in the movable die 3 is pushed out of the die surface, thereby the molded product 1 is ejected and removed.

The moving distance of the ejector pin 4 when a molded product 1 is pushed out can be determined based on the output of the rotational angle detector 16. The force of pushing the ejector pin 4 can be determined from the driving torque (that is, driving current) of the servomotor 15.

The control system 20 for driving the ejector pin 4 comprises an ejector control amplifier 21, a sensor input unit 22, a storage/arithmetic unit 23, a man-machine interface (MMI/F) 24 and a control output unit 25. The ejector control amplifier 21 captures the driving torque and the rotation angle of the servomotor 15 for driving the ejector pin 4 and controls the operation of the servomotor 15. The sensor input unit 22 receives data of the driving torque and rotation angle of the servomotor 15 transmitted from the ejector control amplifier 21 and sends them to the storage/arithmetic unit 23. The storage/arithmetic unit 23 determines operation conditions of the servomotor 15 based on the instructions input by the operator through the man machine interface 24 and sends instructions to the control output unit 25. The control output unit 25 controls the operation of the servomotor 15 by sending a control signal to the ejector control amplifier 21.

Now, the method of detecting a malfunction during the ejecting step, in which a molded product 1 is removed from the movable die 3 by using the ejector pin, will be explained as to the case of the electric ejection-molding machine shown in FIG. 1.

First, as shown in FIG. 2, when a molded product 1 is normally removed from the dies, a pattern showing the driving torque of the serve motor 15 with time is obtained and recorded as a reference pattern. In FIG. 2, the ejection initiation time is plotted on the origin point of the horizontal axis.

Then, as shown in FIG. 3, one or more monitoring zones are set on the reference pattern and the upper and lower limits of the driving torque in each monitoring zone are set. The monitoring zones and the upper and lower limits thus set can be input by the operator into the control system 20 of the injection-molding machine.

During the ejection step when a torque falls outside the upper and lower limits of any one of the monitoring zones, the control system 20 judges that a malfunction occurs. When a malfunction is detected, an alarm is raised to call the operator's attention and then the machine is stopped for safety's sake.

In this case, the accuracy of detecting a malfunction can be improved by adequately setting a monitoring zone or zones on the reference pattern. The monitoring zone is usually set within the period during which a relatively constant driving torque is obtained or the period during which a specific pattern due to a malfunction is likely to appear.

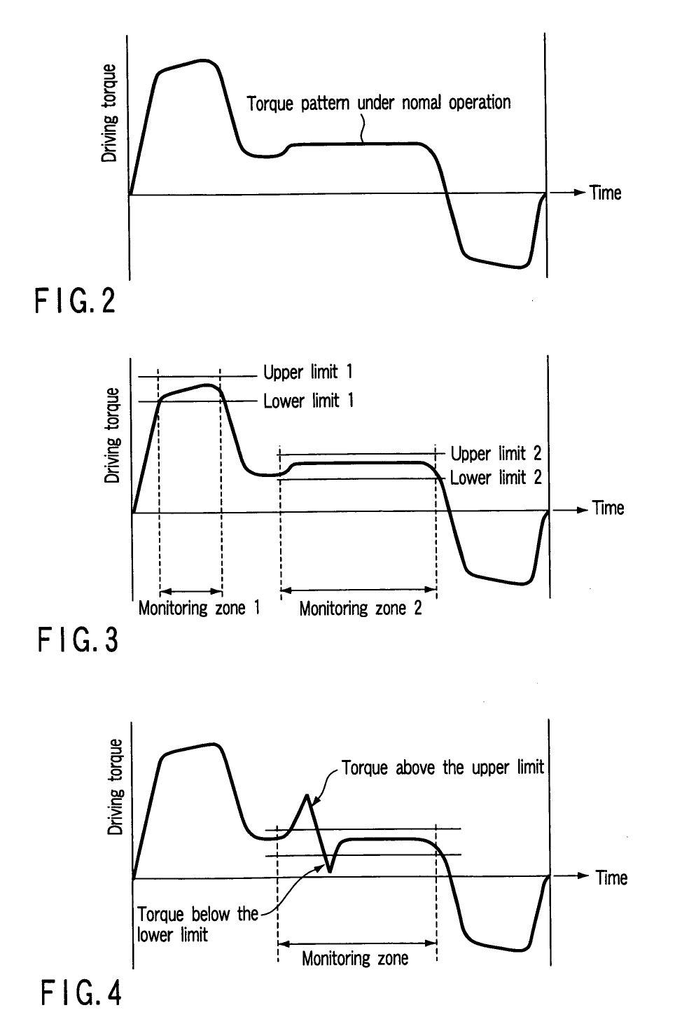

FIG. 4 shows a pattern showing the change of driving torque with time when a malfunction is detected. In this pattern, an abnormal peak of driving torque appears when the ejector pin 4 is pressed into a molded product 1.

In the aforementioned example, change of driving torque with time is monitored. Instead, change of driving torque with respect to the position of the ejector pin 4 in the die may be monitored. In this case, a reference pattern, which shows change of driving torque of the servomotor 15 with respect to the position of an ejector pin, is first obtained in a normal operation (during which a molded product 1 is normally removed). Second, monitoring zones are set on the reference pattern and the upper and lower limits of the driving torque in each of the monitoring zones are set. In this case, the position of the ejector pin 4 (or ejector plate 5) may not be directly detected but determined by the output from the rotational angle detector 16 attached to the servomotor 15.

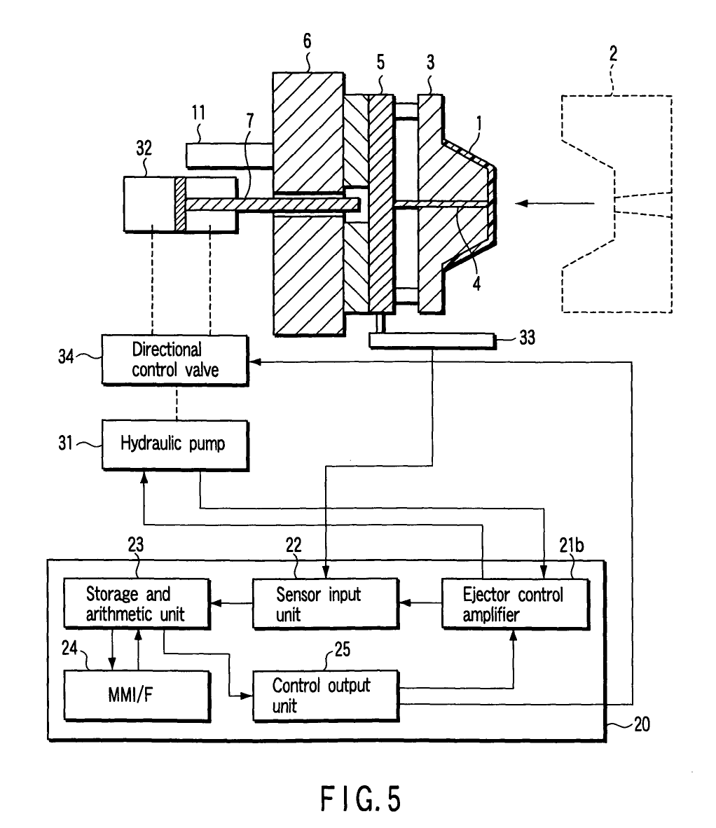

The malfunction detection method mentioned above may be similarly applied to a hydraulic injection-molding machine. FIG. 5 shows a schematic diagram illustrating the structure of a hydraulic injection molding machine. In the figure, reference numeral 31 represents a variable hydraulic pump, 32 a hydraulic actuator, 33 a position detector, 34 a directional control valve, and 21b an ejector control amplifier.

In this case, a hydraulic driving mechanism for the ejector pin is used in place of the motorized driving mechanism used in the previous example. To explain more specifically, the hydraulic actuator 32, and the variable hydraulic pump 31 for driving the hydraulic actuator 32, the directional control valve 34 which changes the moving direction of the hydraulic actuator 32 are used in place of the feed screw 12 and the servomotor 15. The ejector control amplifier 21b controls the variable hydraulic pump 31 while monitoring the pressure of the pump 31. The position of the ejector pin 4 is detected by the position detector 33.

As is explained above, according to the present invention, it is possible to accurately detect a malfunction during the step of ejecting the ejector pin of the injection-molding machine. In addition, a large amount of data needs not to be stored in the memory of the control system.

What is claimed is:

1. A method of detecting a malfunction in an electric injection-molding machine, the method being applied to the step of ejecting a molded product by pushing an ejector pin out of a die, comprising:
obtaining a pattern showing torque of an ejector-pin driving motor versus time or a position of an ejector pin when a molded product is normally removed:
setting in advance at least one monitoring zone based on the pattern and the upper and lower limits of torque in each of the monitoring zones; and
monitoring a torque value in each of the monitoring zones during the ejecting step, judging that a malfunction occurs when the torque value falls outside the upper and lower limits of the monitoring zone, and raising an alarm.

2. A method of detecting a malfunction in an electric injection-molding machine, the method being applied to the step of ejecting a molded product by pushing an ejector pin out of a die, comprising:
obtaining a pattern showing torque of an ejector-pin driving motor versus time or a position of an ejector pin when a molded product is normally removed:
setting in advance at least one monitoring zone based on the pattern and the upper and lower limits of torque in each of the monitoring zones;
monitoring a torque value in each of the monitoring zones during the ejecting step, judging that a malfunction occurs when the torque value falls outside the upper and lower limits of the monitoring zone, and counting the number of malfunctions; and
raising an alarm when the number of malfunctions in a single ejection step reaches a predetermined number.

3. A method of detecting a malfunction in an electric injection-molding machine, the method being applied to the step of ejecting a molded product by pushing an ejector pin out of a die, comprising:
obtaining a pattern showing torque of an ejector-pin driving motor versus time or a position of an ejector pin when a molded product is normally removed:
setting in advance at least one monitoring zone based on the pattern and the upper and lower limits of torque in each of the monitoring zones;
monitoring a torque value in each of the monitoring zones during the ejecting step, judging that a malfunction occurs when the torque value the upper and lower limits of the monitoring zone, and counting the number of malfunctions; and
raising an alarm when the number of malfunctions occurring within a predetermined time reaches a predetermined number.

4. A method of detecting a malfunction in a hydraulic injection-molding machine, the method being applied to the step of ejecting a molded product by pushing an ejector pin out of a die, comprising:
obtaining a pattern showing hydraulic pressure of an ejector-pin driving hydraulic pump versus time or a position of an ejector pin when a molded product is normally removed:
setting in advance at least one monitoring zone based on the pattern and the upper and lower limits of hydraulic pressure in each of the monitoring zones; and
monitoring a hydraulic pressure value in each of the monitoring zones during the ejecting step, judging that a malfunction occurs when the hydraulic pressure value falls outside the upper and lower limits, and raising an alarm.

5. A method of detecting a malfunction in an hydraulic injection-molding machine, the method being applied to the step of ejecting a molded product by pushing an ejector pin out of a die, comprising:
obtaining a pattern showing hydraulic pressure of an ejector-pin driving hydraulic pump versus time or a position of an ejector pin when a molded product is normally removed:
setting in advance at least one monitoring zone based on the pattern and the upper and lower limits of hydraulic pressure in each of the monitoring zones;
monitoring a hydraulic pressure value in each of the monitoring zones during the ejecting step, judging that a malfunction occurs when the hydraulic pressure value falls outside the upper and lower limits, and counting the number of malfunctions; and
raising an alarm when the number of malfunctions in a single ejection step reaches a predetermined number.

6. A method of detecting a malfunction in a hydraulic injection-molding machine, the method being applied to the step of ejecting a molded product by pushing an ejector pin out of a die, comprising:
obtaining a pattern showing hydraulic pressure of an ejector-pin driving hydraulic bump time or a position of an ejector pin when a molded product is normally removed:
setting in advance at least one monitoring zone based on the pattern and the upper and lower limits of hydraulic pressure in each of the monitoring zones; and
monitoring a hydraulic pressure value in each of the monitoring zones during the ejecting step, judging that a malfunction occurs when the hydraulic pressure value falls outside the upper and lower limits of the monitoring zone, and counting the number of malfunctions; and
raising an alarm when the number of malfunctions occurring within a predetermined time reaches a predetermined number.
